(19) United States
(12) Patent Application Publication
(10) Pub. No.: US 2006/0157335 A1
(43) Pub. Date: Jul. 20, 2006

(54) Low energy vacuum distillation method and apparatus

(76) Inventors: Michael R. Levine, Boca Raton, FL (US); Daniel Raviv, Boca Raton, FL (US); Brandon A. Moore, Fort Lauderdale, FL (US); Eiki Martinson, Lighthouse Point, FL (US); Thomas Joseph Kelly, Boca Raton, FL (US)

Correspondence Address: Allen M. Krass;Gilford, Krass, Groh, Sprinkle,, Anderson & Citkowski, P.C., 2701 Troy Center Drive, Suite 330, Troy, MI, 48084-4741, US

(21) Appl. No.: 11/272,627

(22) Filed: Nov. 14, 2005

Related U.S. Application Data
(63) Continuation-in-part of application No. 11/184,754, filed on Jul. 19, 2005.
(63) Continuation-in-part of application No. 11/035,339, filed on Jan. 13, 2005.
(63) Continuation-in-part of application No. 10/665,457, filed on Sep. 19, 2003.
(63) Continuation-in-part of application No. 11/140,657, filed on May 27, 2005.
(60) Provisional application No. 60/412,230, filed on Sep. 20, 2002.
(60) Provisional application No. 60/498,083, filed on Aug. 26, 2003.
(60) Provisional application No. 60/627,884, filed on Nov. 15, 2004.

(51) Int. Cl. B01D 3/10

(52) U.S. Cl. 202/205; 202/236; 202/186; 202/172

(57) ABSTRACT

A subatmospheric pressure desalinating still employs a closed top, open bottom pipe filled with source water to be distilled, such as seawater, having a height greater than the height of a column of seawater that can be supported by the pressure at the bottom of the tank so that a subatmospheric pressure volume is formed at the top. Water from the source is also pumped into the subatmospheric volume and passed through an evaporator which enlarges its surface volume. A small percentage of the water is vaporized and the balance is cooled to provide the heat of vaporization and falls into the top of the seawater column, creating a downward flow. The vapor is drawn from the vacuum and condensed, preferably in a second subatmospheric volume above a column of fresh water. A degasser for the water to be distilled prevents the accumulation of gases dissolved in the seawater or the like in the subatmospheric volume.

### RELATED APPLICATIONS

This application is a continuation-in-part of U.S. patent application Ser. No. 11/184,754 filed Jul. 19, 2005 and Ser. No. 11/035,339 filed Jan. 13, 2005, which are continuations-in-part of U.S. patent application Ser. No. 10/665,457 filed Sep. 19, 2003, which claims priority of U.S. Provisional Patent Application Ser. Nos. 60/412,230, filed Sep. 20, 2002 and 60/498,083, filed Aug. 26, 2003. This application is also a continuation-in-part of U.S. patent application Ser. No. 11/140,657, filed May 27, 2005. This application also claims priority from U.S. Provisional Patent Application Ser. No. 60/627,884 filed Nov. 15, 2004. The entire content of each application is incorporated herein by reference.

### BACKGROUND OF THE INVENTION

1. Field of the Invention

This invention relates to a system for distilling seawater or polluted water to produce fresh water.

2. Background Art

A number of devices and methods have been utilized to purify seawater and brackish water to produce water of lower salinity for irrigation or drinking purposes. Because of the complexity and high power requirements of these systems they have had only limited commercial application.

U.S. Pat. No. 6,436,242 discloses a water distiller using a subatmospheric boiler which employs a vacuum pump to reduce the pressure at the top of a tank below that of the atmosphere. The system additionally employs a compressor for the vapor which is presumably powered from an external power supply. The energy requirements for this system are high and its complexity limits its use to specialized situations.

### SUMMARY OF THE INVENTION

The present invention is directed toward a still useful as a desalinator which is extremely simple so as to be low in initial cost and almost maintenance free, to a condenser employing similar features useful to condense the vapor output of the still of the present invention or other stills, and to a degasser to eliminate the accumulation of water-absorbed atmospheric gases in the apparatus.

The system of the present invention utilizes a subatmospheric still in which the low pressure is preferably obtained by a liquid column closed at its top and opened at its bottom to a body of seawater, the column having a vertical height greater than the height of a column of seawater that can be supported by the atmospheric pressure that is exerted on the bottom of the column, so that a near vacuum is created at the top of the column. The seawater at the top of the column boils or evaporates into this near-vacuum volume. Additionally, seawater is drawn from the source by a pump and introduced into the near-vacuum volume. A small fraction of the seawater vaporizes and the larger fraction is naturally cooled to provide the heat needed for vaporization. The surplus seawater falls by gravity down the column. Vapor from the near-vacuum volume is drawn off by either a vapor compressor, fan, or under favorable circumstances, by lower near-vacuum subatmospheric pressure in a condenser.

The withdrawn vapor may be condensed in a second, near-vacuum chamber that is connected by a water column to a reservoir of cool fresh water such as an aqueduct, an aquifer or the like. The vapor withdrawn from the evaporator near-vacuum volume flows into the condenser near-vacuum volume. Pressurized fresh water from the reservoir is introduced into the condenser vacuum volume and condenses the vapor which falls by gravity into the fresh water column.

As the water to be desalinated is vaporized, gases which are absorbed in the water are released and tend to increase the pressure at the top of the column. The present invention includes apparatus for degassing the water before vaporization or condensation. The percentage of gases in the water to be desalinated can also be reduced by drawing the water from the depths of the body of source water, such as an ocean, rather than from the top, since the percentage of absorbed gases in a deep body of water are inversely proportional to the depth.

The still column of the present invention could be supported directly on the bottom of a body of water to be purified. A series of these stills whose pumps might be powered by wind could be positioned along the coast in the same manner that wind turbines are located in areas of high wind velocity and their fresh water outputs could be pooled to form a relatively high volume source.

Other objects, advantages and applications of the invention will be made apparent by the following description of the preferred embodiment of the invention. The description makes reference to the accompanying drawings in which:

### BRIEF DESCRIPTION OF THE DRAWING

FIG. 1 is a schematic diagram of a first embodiment of an evaporator formed in accordance with the invention;

FIG. 2 is a schematic diagram of a condenser formed in accordance with the invention;

FIG. 3 is a schematic diagram of an evaporator-condenser system formed in accordance with the invention; and

FIG. 4 is a schematic diagram of a degassing system for use with the evaporators and/or condensers of the invention.

### DETAILED DESCRIPTION OF THE INVENTION

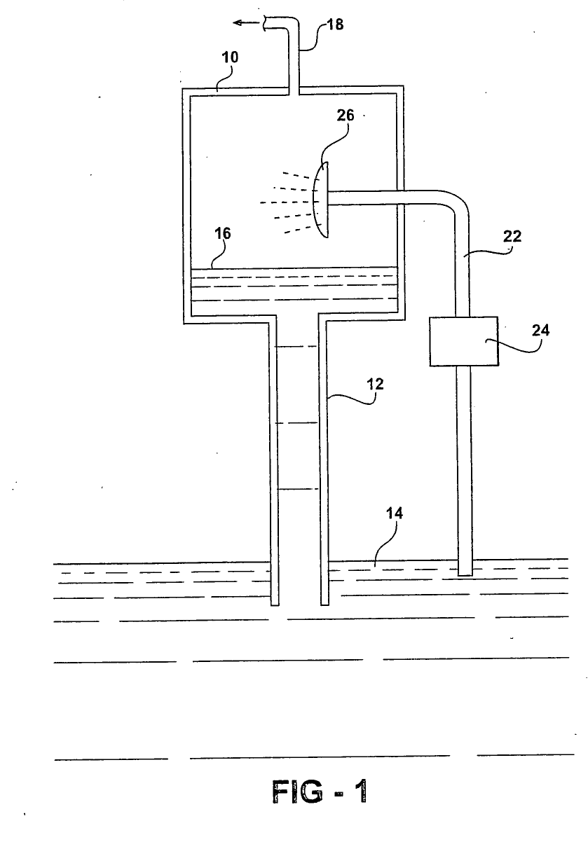

A preferred embodiment of the invention is schematically illustrated in FIG. 1. The system employs a chamber 10, which is generally sealed and has its lower end connected to an exit pipe 12 which in turn has its lower end disposed in a body of water to be purified 14, preferably seawater or brackish water, hereinafter termed “source water”. The height of the water column in pipe 12 is such that the surface 16 of the water level within the chamber 10 is at the maximum height that can be supported by the atmospheric pressure on the lower end of the conduit 12 less the subatmospheric pressure within the chamber 10, typically approximately 10 meters. As a result, the volume in the chamber 10 above the water surface 16 is substantially evacuated to a subatmospheric pressure (a “near-vacuum”) and filled with water vapor at a vapor pressure corresponding to the temperature of the water in the chamber 10. The water vapor drawn out of the chamber 10 through conduit 18 represents the distilled output of the evaporator.

The chamber 10 simply constitutes an enlargement of the pipe 12 which acts to enlarge the surface area at the top of the column.

To enhance the generation of water vapor within the chamber 10, it is desirable to maintain the maximum temperature within the chamber 10. Accordingly, undistilled water from the source body 14 is pumped up a conduit 22 by a pump 24. The pump has an outlet within the evaporator chamber 10 and its output is through one or more spray heads 26 within the volume 10. The spray acts to maximize the surface area of the introduced water. In alternative embodiments the pumped water could be cascaded over inclined planar surfaces or otherwise operated on to maximize its area exposed to the vacuum and thus enhance the evaporization of the water introduced. It may be generically termed an “evaporator.” The volume of water pumped through the conduit 22 is such that only a small percentage of the undistilled water forced out of the spray head 26 is vaporized. The larger volume of spray joins the body of water within the volume 10 and causes a downward flow through the exit pipe 12, maintaining the vacuum in the chamber 10 and an almost constant water level.

Assuming that 1% of the spray through the head 26 is vaporized, the approximately 540 calories of vaporization per gram vaporized will cool the other 99% of the water. Accordingly, if 100 grams of water is pumped through the conduit 22, the water which is not vaporized by the spray head is lowered in temperature by about 5.4° C. This process maintains the temperature in the chamber 10 despite the cooling effect of the vaporization.

The system may be initialized by opening the chamber 10 to the atmosphere, closing the bottom of the exit 12, filling the chamber 10 and column with seawater, and then closing the chamber 10 to the atmosphere and opening the bottom of the tube 12.

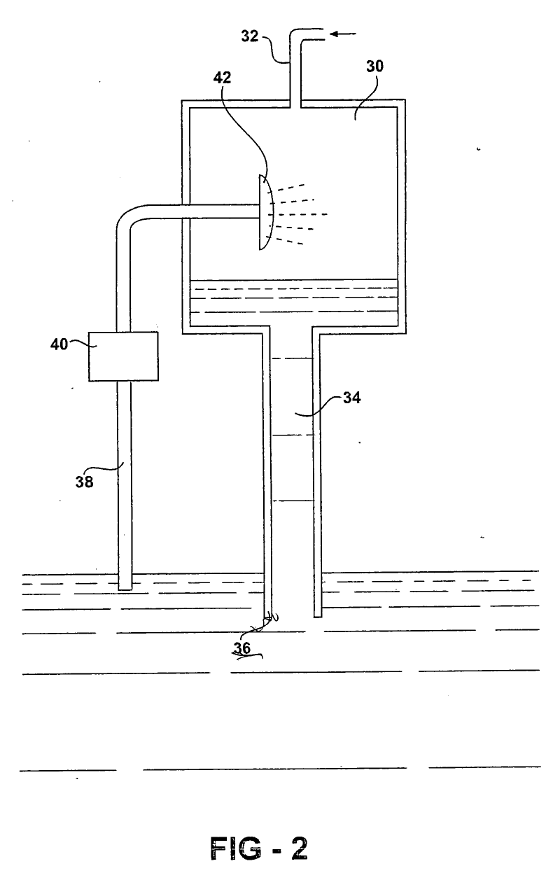

FIG. 2 is an illustration of a condenser embodying similar principles to the evaporator of FIG. 1. A chamber 30 is supplied with water vapor at a reduced pressure from a conduit 32. The chamber 30 is connected to a conduit 34 that has its lower end disposed within a body of fresh water 36 which may be an aquifer to be replenished by the condensate, an aqueduct, or the like. Again, the height of the water column in the conduit 34 is the maximum level that may be sustained by the atmospheric pressure on the body of fresh water 36. Thus, a volume filled with water vapor is formed at the top end of the chamber 30. Fresh water from the body 36 is pumped upwardly through a conduit 38 by a pump 40 and exits within the evacuated area at the top of the chamber 30 by one or more sprays 42 or other evaporator apparatus for maximizing the surface area of the water introduced into the chamber 30. The portion of the fresh water which does not evaporate joins the water in the conduit 34, causing a downward flow from the chamber 30 to the main body of water 36. The cool spray water will condense the vapor introduced through the conduit 32 on itself. This condensation will heat the water introduced, causing a temperature increase for fresh water leaving the conduit 34. This heated water is being replaced by cool water coming in the spray head thus providing a colder surface for condensation.

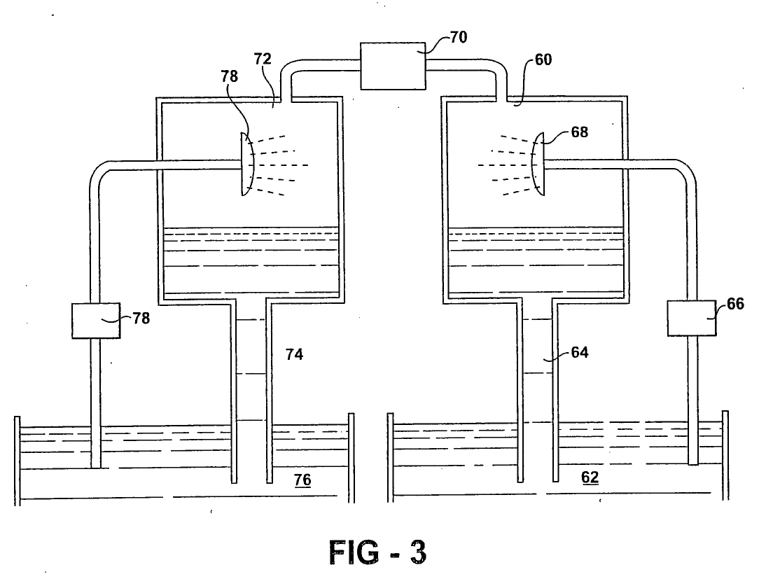

FIG. 3 shows another alternative embodiment of the invention comprising a system in which a pair of near-vacuum devices are employed, one having a column of salt water and acting as an evaporator and the second having a column of fresh water and acting as a condenser, with a vapor compressor communicating their two vacuum spaces. A first enclosed chamber 60 is connected to a source of seawater 62 to be distilled, by a column 64 which, together with the chamber 60, has a height exceeding the height which can be supported by the atmospheric pressure at the bottom of the column, so as to produce a near-vacuum in the chamber 60, above the water level in the column. The chamber 60 is provided by a spray of seawater via a pump 66, feeding a spray head 68 within the chamber 60. The pump draws from the body of seawater 62. The vapor which results from the spray action is drawn out of the chamber 60 by a pump 70, which feeds a second chamber 72 having its column 74 suspended within a body of fresh water 76. A pump 78 draws fresh water from the source 76 and forces it through a spray head 78.

The energy required to drive the pump 70 is a function of the difference in temperature between the seawater source 62 and the fresh water 76. The unit 72 acts as a condenser, and the cooler the fresh water sprayed into the tank 72, the greater the pressure differential between the tanks 60 and 72, and the less energy required by the pump 70. With a sufficiently cool supply of heat exchanging water for the condenser, no pump is required, rather the lower vapor pressure in the condenser will draw vapor from the higher pressure evaporator without the need for a pump. The lower pressure in the condenser chamber allows removal of the water vapor.

Normally water contains dissolved atmospheric gases. When the pressure above the water is reduced, some of these dissolved gases tend to expand and become part of the water vapor gas mix above the water surface. Under near-vacuum conditions as in the chamber of the evaporator or condenser, this may lead to increased pressure in the chamber and consequently could slow or halt the evaporation by boiling process.

A degassing unit may be added before either an evaporator or a condenser to reduce the effect of this phenomenon.

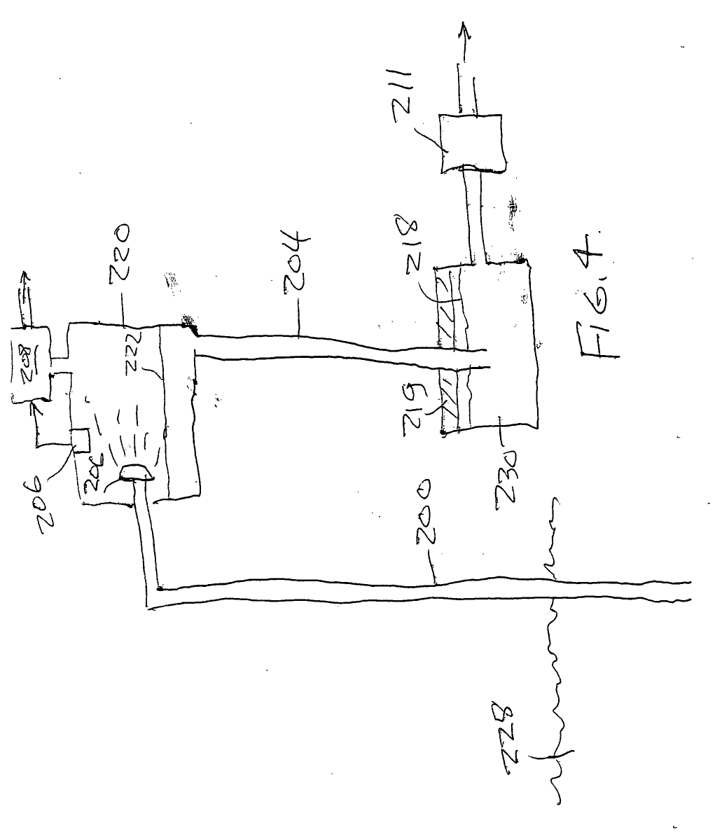

FIG. 4 illustrates a preferred embodiment of such a degassing unit. Water 228 to be degassed is pumped or siphoned through conduit 200 and sprinkled through spray 206 to the near-vacuum space 220. The water mist and the water under water line 222 are mostly degassed. The dissolved gases released by the spray are pumped out of the degassing unit using pump 208. Most degassed water is drawn out from exit pipe 210 connected to storage tank 220 by a pump 211 at about the same rate as the incoming water. Any difference in water flow is compensated by change in water level 218. Degassed water in tank 230 is covered by Styrofoam 219, floating liquid, or the like to partially prevent the atmospheric gases from dissolving back into the degassed water. In addition, the atmospheric pressure above the Styrofoam is useful to squeeze the atmospheric gas bubbles below the Styrofoam back into the solution and to help avoiding moving the bubbles to the next stage.

The subatmospheric pressure in chamber 220 should be kept higher than vapor pressure to minimize boiling using a pressure sensor 226 and a feedback control system to control the pump 208. An alternative method (not shown) is to reestablish the near-vacuum pressure in a degassing column by displacing the gas with degassed water periodically.

Multi-stage degassing units may be connected in series to enhance the degassing process. This can be done by connecting the output water of one degassing unit to the incoming water of the next unit.

Whenever possible it is advantageous to pull the water from deep below the surface of body 228 via conduit 200 by making it as long as practical, since deep water has less dissolved gases.

Having thus described my invention, I claim:

1. An apparatus for a liquid to be distilled, comprising:
a first conduit having an opened lower end disposed within a body of the liquid to be distilled and extending upwardly from the body to a closed top, the conduit being filled with the liquid to be distilled so as to create a column of liquid having a height equal to the level of such column that can be supported by the pressure on the body of source liquid and to create a subatmospheric volume within the closed top;
an evaporator disposed within said subatmospheric volume operative to receive pressurized liquid from the body of source liquid and increase its surface area, wherein a portion of the source liquid evaporates into the subatmospheric volume and the remaining portion of the source liquid falls down the column; and
a second conduit for withdrawing vapor to be condensed from the subatmospheric volume.

2. The apparatus of claim 1, wherein the volume of source liquid introduced into the vacuum area is substantially greater than the volume of source liquid that evaporates within the subatmospheric volume so that the larger portion of the introduced source liquid falls down the column, providing the heat of vaporization for the evaporated source liquid.

3. The apparatus of claim 1 in which the pressurized source liquid is pumped into the vacuum volume from the body of source liquid.

4. The apparatus of claim 1 in which the evaporator comprises a spray head.

5. The apparatus of claim 1 in which the liquid is seawater.

6. A still for source water, comprising:
a body of source water;
a first chamber formed at the top of a first column of source water to be distilled which has its lower end disposed within said body of source water, the height of such first column being equal to the level that can be supported by the pressure at the lower end of the first column so as to produce a vacuum volume within the top of the chamber;
a first evaporator disposed within the vacuum at the top of the first chamber operative to receive pressurized source water from the body and increase its surface area;
a body of water pure relative to said source water;
a second chamber formed at the top of a second column of relatively pure water connecting at its lower end to said body of relatively pure water, the height of the column being equal to the level that can be supported by the pressure and the lower end of the second column so as to produce a vacuum volume at the top of the second chamber;
a second condenser disposed within the vacuum at the top of the second chamber operative to pressurize water from said body of relatively pure water and increase its surface area; and
a conduit connecting vapor from the vacuum at the top of the first chamber to the vacuum at the top of the second chamber, whereby the first chamber acts as an evaporator and the second chamber acts as a condenser.

7. The still of claim 6 wherein the volume of water introduced into the vacuum at the top of the first chamber by the first evaporator is substantially larger than the volume of that water which evaporates, with the balance of the water falling into the top of the first column and providing the heat of vaporization for the portion of water which is evaporated.

8. The still of claim 6 further comprising a pump disposed in the conduit connecting vapor from the vacuum at the top of the first chamber to the vacuum at the top of the second chamber.

9. The still of claim 6 wherein the temperature of the body of relatively pure water is less than the temperature of the body of the source water, reducing or eliminating the need for the pump for pumping vapor from the vacuum at the top of the first chamber to the vacuum at the top of the second chamber.

10. A condenser for vapor comprising:
a conduit having an open bottom connected to a reservoir of liquid and having a closed top elevated above the surface of the liquid in the reservoir to form a column having a vertical height equal to the height that can be supported by the pressure on the body of liquid, thereby producing a subatmospheric pressure volume within the conduit at the top of the column;
a source of vapor at higher pressure than said subatmospheric pressure connected to said subatmospheric volume; and
a surface area expander within the subatmospheric volume operative to receive pressurized liquid from the source so that the pressurized liquid introduced through the expander contacts the heated vapor and condenses the vapor so that it falls into the column.

11. The condenser of claim 10 in which the surface area expander comprises a spray head.

12. The condenser of claim 10 in which the source of the vapor is an evaporator of the type defined in claim 1.

13. The condenser of claim 10 wherein the volume of water introduced into the vacuum at the top of the first chamber by the spray head is substantially larger than the volume of the water which condenses, with the condensate and the unevaporated portion of the spray water falling into the top of the first column thereby removing both the heat of condensation and the condensate down the column.

14. The condenser of claim 10 wherein the temperature of the body of relatively pure water is less than the temperature of the body of the source water, reducing or eliminating the need for the pump for pumping vapor from the vacuum at the top of the first chamber to the vacuum at the top of the second chamber.

15. The condenser of claim 10 wherein the liquid is purer than the liquid from which the vapor is produced.

16. An apparatus for degassing liquid comprising:
a source of liquid to be degassed;
a first conduit having an opened lower end disposed within a reservoir and extending upwardly from the reservoir into a closed degassing chamber, the conduit being filled with degassed liquid so as to create a column of degassed liquid having a height equal to the level of such column that can be supported by the pressure on the reservoir of degassed liquid and to create a subatmospheric volume within the chamber;
a spray disposed in said chamber; and
means for delivering liquid to be degassed to the spray, whereby absorbed gases in the sprayed liquid are separated from the sprayed liquid in the subatmospheric pressure of the chamber and the degassed source water falls onto the top of the column.

17. The apparatus of claim 16 including a pump for withdrawing the separated gases from the degasser chamber.

18. The apparatus of claim 17 including a sensor for measuring the gas pressure in the degasser chamber and controlling the pump.

19. The apparatus of claim 16 including a pump for delivering degassed liquid from the reservoir to an evaporator still at a rate commensurate with the rate of addition of degassed liquid to the top of the column.

20. The apparatus of claim 19 wherein the evaporator still constitutes the apparatus of claim 1.

21. The apparatus of claim 16 including a pump for delivering degassed liquid from the reservoir to a condenser at a rate commensurate with the rate of addition of degassed liquid to the top of the column.

22. The apparatus of claim 21 wherein the condenser constitutes the apparatus of claim 10.
